(19) United States
(12) Patent Application Publication
(10) Pub. No.: US 2023/0171084 A1
(43) Pub. Date: Jun. 1, 2023

(54) APPRATUS AND METHOD WITH HOMOMORPHIC ENCRYPTION

(71) Applicants: Samsung Electronics Co., Ltd., Suwon-si (KR); INHA-INDUSTRY PARTNERSHIP INSTITUTE, Incheon (KR)

(72) Inventors: Sunmin KWON, Seoul (KR); Hanho LEE, Incheon (KR); Phap Ngoc DUONG, Incheon (KR); Dong-Hoon YOO, Suwon-si (KR)

(73) Assignees: Samsung Electronics Co., Ltd., Suwon-si (KR); INHA-INDUSTRY PARTNERSHIP INSTITUTE, Incheon (KR)

(21) Appl. No.: 17/961,828

(22) Filed: Oct. 7, 2022

(30) Foreign Application Priority Data
Nov. 26, 2021 (KR) 10-2021-0165593

(51) Int. Cl. H04L 9/00

(52) U.S. Cl. CPC H04L 9/008

(57) ABSTRACT

An apparatus with homomorphic encryption includes: a first memory configured to receive and store a polynomial; a second memory configured to store a twiddle factor; a number theoretic transform (NTT) module configured to perform an NTT operation on the polynomial based on the twiddle factor; and a controller configured to control the first memory, the second memory, and the NTT module, wherein the NTT module comprises a butterfly unit (BU) array that comprises a plurality of BUs configured to, for the performing of the NTT operation, perform a modular operation on coefficients of the polynomial.

### CROSS-REFERENCE TO RELATED APPLICATIONS

This application claims the benefit under 35 USC § 119(a) of Korean Patent Application No. 10-2021-0165593, filed on Nov. 26, 2021 in the Korean Intellectual Property Office, the entire disclosure of which is incorporated herein by reference for all purposes.

### BACKGROUND

### 1. Field

The following description relates to an apparatus and method with homomorphic encryption.

### 2. Description of Related Art

Artificial intelligence (AI) technology may include mutually symmetrical technical requirements to ensure privacy of data that includes sensitive information. Even with the advent of the quantum computing era, technology capable of solving complex requirements such as safe data security technology is required. With cloud computing technology, there may be concerns about personal data privacy, security, and confidentiality.

Homomorphic encryption technology is a technology that may be capable of solving the aforementioned complex requirements. To use the homomorphic encryption technology, it is necessary to develop System on Chip (SoC) technology for an encryption data fully homomorphic encryption processing accelerator that raises a current slow fully homomorphic encryption processing speed to an effective level.

The homomorphic encryption technology refers to an encryption method that may operate data in an encrypted state. Here, an operation result using ciphertexts becomes a new ciphertext and a plaintext decrypted from the ciphertext may be the same as an operation result of data before encryption.

The homomorphic encryption technology may perform arithmetic operations on lattice-based encrypted data that is a type of quantum-resistant encryption and thus, is attaining a high attention. However, when original data is encrypted, a word size of data may increase, which may lead to increasing an operation processing time between ciphertexts. Therefore, operation performance is degraded.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an apparatus with homomorphic encryption includes: a first memory configured to receive and store a polynomial; a second memory configured to store a twiddle factor; a number theoretic transform (NTT) module configured to perform an NTT operation on the polynomial based on the twiddle factor; and a controller configured to control the first memory, the second memory, and the NTT module, wherein the NTT module comprises a butterfly unit (BU) array that comprises a plurality of BUs configured to, for the performing of the NTT operation, perform a modular operation on coefficients of the polynomial.

The BU array may be configured by two-dimensionally arranging the plurality of BUs.

The polynomial may include a first coefficient and a second coefficient, and for the performing of the NTT operation, each of the plurality of BUs may include: a multiplier configured to perform a multiplication on the twiddle factor and the second coefficient; a modular reduction operator configured to perform a modular reduction on an output of the multiplier; an adder configured to add an output of the modular reduction operator and the first coefficient; a modular addition performer configured to perform a modular addition on an output of the adder; a subtractor configured to perform a subtraction between the first coefficient and an output of the modular reduction operator; and a modular subtraction operator configured to perform a modular subtraction operation on an output of the subtractor.

The NTT operation may include a predetermined number of stages, and for the performing of the NTT operation, the NTT module may be configured to perform the NTT operation based on a radix corresponding to the predetermined number.

The predetermined number may be determined based on an order of the polynomial.

The twiddle factor may be determined based on an order of the polynomial.

The second memory may be configured to, for the storing of the twiddle factor, store the twiddle factor in bit-reversed order in a number of memory banks that is determined based on an order of the polynomial.

For the controlling, the controller may be configured to: determine an iteration count of the NTT module; measure a number of receptions of an input coefficient according to a progress step of the plurality of BUs; and generate an address for performing read and write operations of the first memory.

For the controlling, the controller may be configured to: generate a bank address and an order for writing a coefficient of the polynomial to the first memory based on the address; and generate a bank address and an order for reading the coefficient of the polynomial from the first memory based on the address and reading the twiddle factor from the second memory.

For the performing of the NTT operation, the NTT module may be configured to: load the input coefficient that is determined based on an order of the polynomial from the first memory during each iteration using the address; and store an NTT operation result in the address.

In another general aspect, a method with homomorphic encryption includes: receiving and storing a polynomial; storing a twiddle factor; performing a number theoretic transform (NTT) operation on the polynomial based on the twiddle factor; and controlling a first memory configured to store the polynomial, a second memory configured to store the twiddle factor, and an NTT module configured to perform the NTT operation, wherein the performing of the NTT operation comprises performing the NTT operation by performing a modular operation on coefficients of the polynomial using a butterfly unit (BU) array that may include a plurality of BUs.

The BU array may be configured by two-dimensionally arranging the plurality of BUs.

The polynomial may include a first coefficient and a second coefficient, and the performing of the NTT operation using the BU array that may include the plurality of BUs may include: performing a multiplication on the twiddle factor and the second coefficient; performing a modular reduction on a result of the multiplication; performing an addition on a result of the modular reduction and the first coefficient; performing a modular addition on a result of the addition; performing a subtraction between the first coefficient and a result of the modular reduction; and performing a modular subtraction operation on a result of the subtraction.

The NTT operation may include a predetermined number of stages, and the performing of the NTT operation may include performing the NTT operation based on a radix corresponding to the predetermined number.

The predetermined number may be determined based on an order of the polynomial.

The twiddle factor may be determined based on an order of the polynomial.

The storing of the twiddle factor may include storing the twiddle factor in bit-reversed order in a number of memory banks that is determined based on an order of the polynomial.

The controlling may include: determining an iteration count of the NTT module; measuring a number of receptions of an input coefficient according to a progress step of the plurality of BUs; and generating an address for performing read and write operations of the first memory.

The controlling further may include: generating a bank address and an order for writing a coefficient of the polynomial to the first memory based on the address; and generating a bank address and an order for reading the coefficient of the polynomial from the first memory based on the address and reading the twiddle factor from the second memory.

The performing of the NTT operation may include: retrieving the input coefficient that is determined based on an order of the polynomial from the first memory during each iteration using the address; and storing an NTT operation result in the address.

In another general aspect, one or more embodiments include a non-transitory computer-readable storage medium storing instructions that, when executed by one or more processors, configure the one or more processors to perform any one, any combination, or all operations and methods described herein.

In another general aspect, an apparatus with homomorphic encryption includes: a first memory configured to store a polynomial; a second memory configured to store a twiddle factor;

and a two-dimensionally arranged butterfly unit (BU) array configured to perform a number theoretic transform (NTT) operation on the polynomial based on the twiddle factor.

The apparatus may include a controller configured to control the first memory, the second memory, and the BU array.

Other features and aspects will be apparent from the following detailed description, the drawings, and the claims.

### BRIEF DESCRIPTION OF THE DRAWINGS

FIG. 1 is a diagram illustrating an example of a homomorphic encryption operation apparatus.

FIG. 2 illustrates an example of implementation of a homomorphic encryption operation apparatus.

FIG. 3 illustrates an example of a number theoretic transform (NTT) operation.

FIG. 4 illustrates an example of implementation of a field programmable gate array (FPGA)-based homomorphic encryption operation apparatus.

FIG. 5 illustrates an example of an NTT operation algorithm.

FIG. 6 illustrates an example of a block diagram of a data storage of a dynamic random access memory (DRAM).

FIG. 7 illustrates an example of a block diagram of a twiddle factor memory.

FIG. 8 illustrates an example of a memory access method of a homomorphic encryption operation apparatus.

FIGS. 9A to 9C illustrate an example of a data access method of a homomorphic encryption operation apparatus.

FIG. 10 illustrates an example of read and write operations according to an iteration.

FIG. 11 illustrates an example of implementation of an NTT module.

FIG. 12 illustrates an example of implementation of an INTT module.

FIG. 13 illustrates an example of implementation of BU₁.

FIG. 14 illustrates an example of implementation of BU₂.

FIG. 15 illustrates an example of implementation of BU₀.

FIG. 16 illustrates an example of implementation of a modular multiplier.

FIG. 17 illustrates an example of implementation of an FPGA-based homomorphic encryption operation apparatus.

FIG. 18 illustrates an example of an NTT operation algorithm.

FIG. 19 illustrates an example of a block diagram of a data storage of a DRAM.

FIG. 20 illustrates an example of a block diagram of a twiddle factor memory.

FIG. 21 illustrates an example of implementation of an NTT module.

FIG. 22 illustrates an example of implementation of an INTT module.

FIG. 23 illustrates an example of an NTT operation performed in a form of a pipeline.

FIG. 24 is a flowchart illustrating an example of an NTT operation.

FIG. 25 is a flowchart illustrating an operation of a homomorphic encryption operation apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known, after an understanding of the disclosure of this application, may be omitted for increased clarity and conciseness.

Although terms such as “first,” “second,” and “third” are used to explain various members, components, regions, layers, or sections, these members, components, regions, layers, or sections are not to be limited by these terms. Rather, these terms should be used only to distinguish one member, component, region, layer, or section from another member, component, region, layer, or section. For example, a “first” member, component, region, layer, or section referred to in the examples described herein may also be referred to as a “second” member, component, region, layer, or section without departing from the teachings of the examples.

Throughout the specification, when a component is described as being “connected to,” “coupled to”, or “accessed to” another component, it may be directly “connected to,” “coupled to”, or “accessed to” the other component, or there may be one or more other components intervening therebetween. In contrast, when an element is described as being “directly connected to,” “directly coupled to”, or “directly accessed to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

The terminology used herein is for describing various examples only and is not to be used to limit the disclosure. The articles “a,” “an,” and “the” are intended to include the plural forms as well, unless the context clearly indicates otherwise. It will be further understood that the terms “comprises” and “comprising,” when used in this specification, specify the presence of stated features, integers, steps, operations, elements, components, or combinations thereof, but do not preclude the presence or addition of one or more other features, integers, steps, operations, elements, components, or combinations thereof. The use of the term “may” herein with respect to an example or embodiment (for example, as to what an example or embodiment may include or implement) means that at least one example or embodiment exists where such a feature is included or implemented, while all examples are not limited thereto.

Unless otherwise defined herein, all terms used herein including technical or scientific terms have the same meanings as those generally understood by one of ordinary skill in the art to which examples belong and after an understanding of the present disclosure. Terms defined in dictionaries generally used should be construed to have meanings matching contextual meanings in the related art and the present disclosure, and are not to be construed as an ideal or excessively formal meaning unless otherwise defined herein.

Hereinafter, the examples are described in detail with reference to the accompanying drawings. Like reference numerals illustrated in the respective drawings refer to like elements and further description related thereto is omitted.

The term “module” used herein may refer to hardware that may perform a function and an operation according to each name described herein, may also refer to hardware that implements a computer program code to perform a specific function and operation, or may refer to a processor and/or a microprocessor, to which the computer program code capable of performing the specific function and operation is loaded.

That is, the module may refer to a functional and/or structural combination of hardware for carrying out the technical spirit of the disclosure and/or software for driving the hardware.

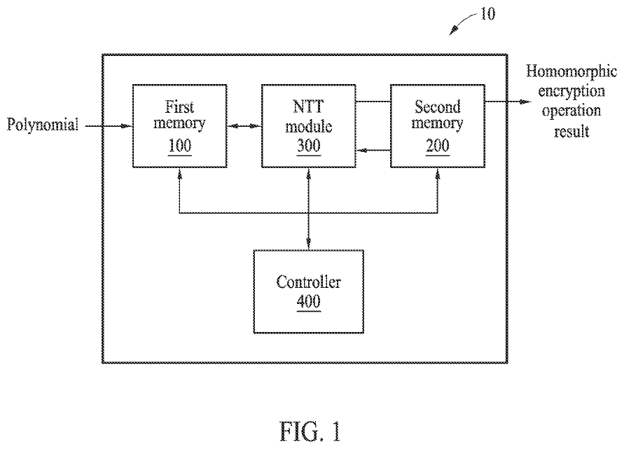

FIG. 1 is a diagram illustrating an example of a homomorphic encryption operation apparatus.

Referring to FIG. 1, a homomorphic encryption operation apparatus 10 may perform a homomorphic encryption operation. Homomorphic encryption may refer to an encryption method that may perform an operation in a state in which data is encrypted. The homomorphic encryption operation may include various operations implemented to perform an operation between encrypted data. The homomorphic encryption operation may include a modulus refresh of a ciphertext and an isomorphic operation between ciphertexts. The ciphertext may refer to encrypted data acquired by encrypting a plaintext.

The homomorphic encryption operation apparatus 10 may output a homomorphic encryption operation result by processing a polynomial. The homomorphic encryption operation apparatus 10 may include a first memory 100 (e.g., one or more memories), a second memory 200 (e.g., one or more memories), a number theoretic transform (NTT) module 300, and a controller 400 (e.g., one or more processors).

The first memory 100 and the second memory 200 may store data for an operation or an operation result. The first memory 100 and the second memory 200 may store instructions or a program executable by a processor. For example, the instructions may include instructions for executing an operation of the processor and/or an operation of each configuration of the processor.

The first memory 100 and the second memory 200 may be or include a volatile memory device or a nonvolatile memory device.

The volatile memory device may be or include a dynamic random access memory (DRAM), a static random access memory (SRAM), a thyristor RAM (T-RAM), a zero capacitor RAM (Z-RAM), or a twin transistor RAM (TTRAM).

The nonvolatile memory device may be or include an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate memory (NFGM), a holographic memory, a molecular electronic memory device, or an insulator resistance change memory.

The first memory 100 may receive and store a polynomial. The polynomial may include a polynomial for generating a ciphertext by encrypting a plaintext and/or a polynomial for performing a homomorphic encryption operation between ciphertexts.

The second memory 200 may include and store a twiddle factor. The twiddle factor may be any constant that is multiplied by data in a transformation algorithm. Any constant may include trigonometric constant coefficients. The twiddle factor may be determined based on an order of the polynomial. The second memory 200 may store the twiddle factor in bit-reversed order in a number of memory banks determined based on the order of the polynomial.

The NTT module 300 may perform an NTT operation on the polynomial based on the twiddle factor. The NTT operation may refer to a discrete Fourier transform having an integer modulo value that includes a prime.

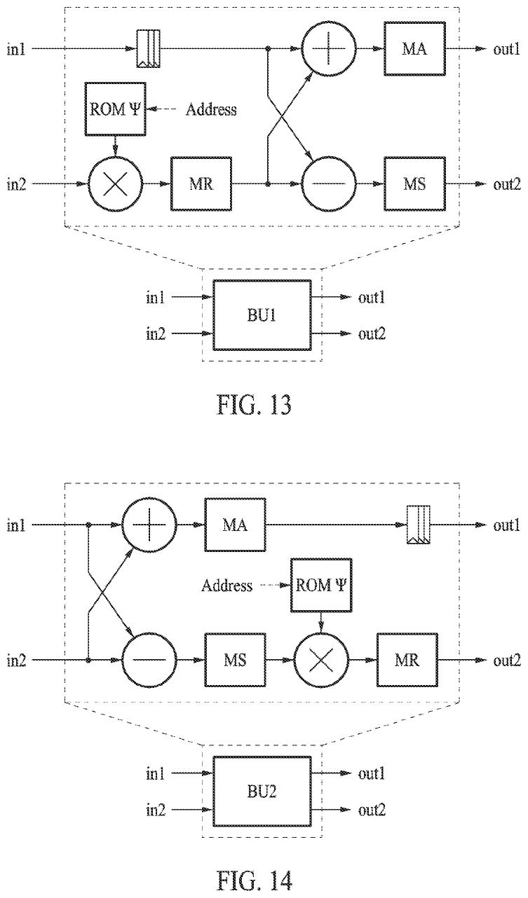

The NTT module 300 may include a butterfly unit (BU) array that includes a plurality of BUs. A non-limiting example of the BU is further described with reference to FIGS. 13 to 15. The BU may perform a modular operation on a coefficient of the polynomial. The polynomial may include a first coefficient and a second coefficient.

The NTT operation may include a predetermined number of stages, and the NTT module 300 may perform the NTT operation based on a radix (e.g., a base) corresponding to the predetermined number. The predetermined number may be determined based on an order (e.g., a degree) of the polynomial.

The NTT module 300 may load an input coefficient that is determined based on the order of the polynomial from the first memory 100 during each iteration using an address for performing read and write operations of the first memory 100, and may store an NTT operation result in the address of the first memory 100.

The BU array may be configured by two-dimensionally arranging the plurality of BUs. Each of the plurality of BUs may include a multiplier configured to perform a multiplication on the twiddle factor and the second coefficient, a modular reduction operator configured to perform a modular reduction on an output of the multiplier, an adder configured to add an output of the modular reduction operator and the first coefficient, a modular addition performer configured to perform a modular addition on an output of the adder, a subtractor configured to perform a subtraction between the first coefficient and an output of the modular reduction operator, and a modular subtraction operator configured to perform a modular subtraction operation on an output of the subtractor.

The controller 400 may be or include a processor (e.g., one or more processors). The processor may process data stored in a memory, for example, the first memory 100 and/or the second memory 200. The processor may execute instructions triggered by a computer-readable code, for example, software, stored in the memory and the processor. The processor may execute instructions stored in a non-transitory computer-readable storage medium (e.g., the memory) that configure the processor to perform (and/or control the first memory 100, the second memory 200, and the NTT module 300 to perform) any one, any combination of, or all operations and methods described herein with reference to FIGS. 1-25.

The term “processor” may be a data processing device that is hardware having circuitry with a physical structure for executing desired operations. For example, the desired operations may include instructions or a code included in a program.

For example, the data processing device be hardware including a microprocessor, a central processing unit, a processor core, a multi-core processor, a multiprocessor, an application-specific integrated circuit (ASIC), and/or a field programmable gate array (FPGA).

The controller 400 may control the first memory 100, the second memory 200, and the NTT module 300. The controller 400 may determine an iteration count of the NTT module 300. The controller 400 may measure a number of receiving (e.g., a number of receptions of) an input coefficient according to a progress step of the plurality of BUs. The controller 400 may generate an address for performing read and write operations of the first memory 100.

The controller 400 may generate a bank address and an order for writing a coefficient of the polynomial to the first memory 100 based on the address. The controller 400 may generate a bank address and an order for reading the coefficient of the polynomial from the first memory 100 based on the address and reading the twiddle factor from the second memory 200.

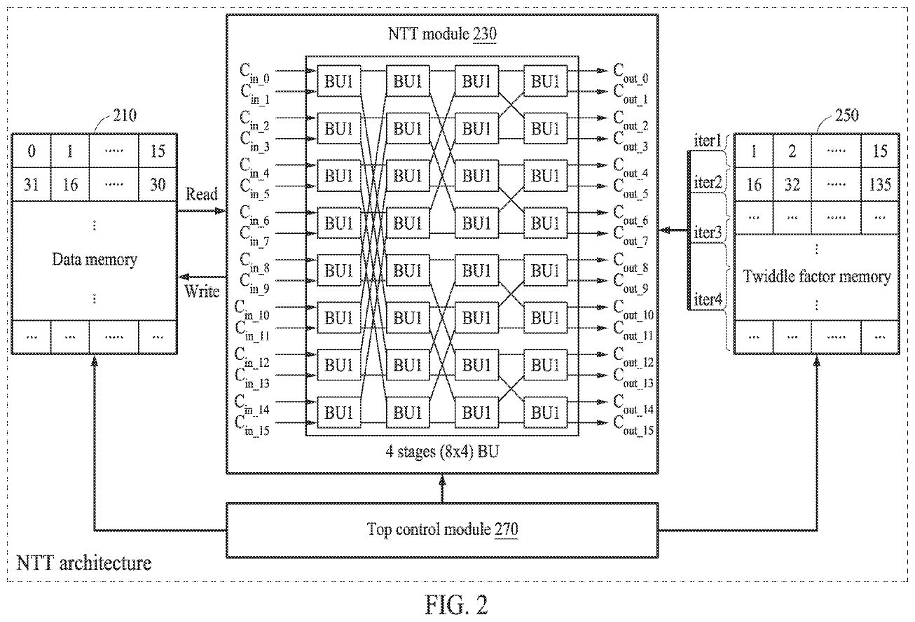

FIG. 2 illustrates an example of implementation of a homomorphic encryption operation apparatus (e.g., the homomorphic encryption operation apparatus 10 of FIG. 1).

Referring to FIG. 2, the homomorphic encryption operation apparatus 10 may include an NTT architecture. The NTT architecture may include a data memory 210 (e.g., the first memory 100 of FIG. 1), an NTT module 230 (e.g., the NTT module 300 of FIG. 1), a twiddle factor memory 250 (e.g., the second memory 200 of FIG. 1), and a top control module 270 (e.g., the controller 400 of FIG. 1).

The NTT module 230 may be configured as a two-dimensional (2D) array type BU to perform an NTT operation of high data processing and may perform the NTT operation during a plurality of iterations.

The data memory 210 and the twiddle factor memory 250 may store an input polynomial and an intermediate result using a non-conflict memory access pattern. The data memory 210 and the twiddle factor memory 250 may include an on-chip memory block of a polynomial size. The twiddle factor memory 250 may store a pre-calculated (e.g., predetermined) twiddle factor corresponding to a selected module.

The NTT architecture may perform the NTT operation using a polynomial of a 60-bit size and 2¹⁶ to perform a work on a lattice-based fully homomorphic encryption scheme.

The plurality of BUs may be grouped in a (r*c) BU array in a 2D arrangement form. For example, in the BU array, 32 BUs may be arranged in a form of 8*4. The 8*4-BU arrangement may include four operation stages each in which eight BUs are sequentially connected and connection between stages may follow a decimal system for the NTT operation.

The top control module 270 may control the NTT module 230 to operate in a plurality of NTT operation iterations. The top control module 270 may control the entire operation of the NTT architecture. A local control circuit may control each of the data memory 210, the twiddle factor memory 250, and the NTT module 230.

The top control module 270 may enable a non-conflict read or write pattern using the local control circuit to access the data memory 210. According to an iteration, the local control circuit may include a read or write controller, and the write controller and the read controller may process a write and read operation using a finite stage machine (FSM).

For a polynomial of size n in a stage of log₂(n), a number (e.g., iteration) of FSM states may be calculated (e.g., determined) by rounding up log₂(n) or log₂(2r). An address of read or write may be changed through an iteration.

The homomorphic encryption operation apparatus 10 of one or more embodiments may perform an efficient BU operation in an NTT module or an INTT module using a storage method of a twiddle factor in an NTT or INTT structure.

The data memory 210 may include a 2*r bank RAM. For example, in the case of an 8*4 BU array NTT module, 16 coefficients may be read and written from the data memory 210 (e.g., an on-chip data memory) through the local control circuit.

The twiddle factor memory 250 may use a multi-on-chip data memory. A number of twiddle factor sets may differ depending on a number of modules used. In the NTT module 230 with an r*c BU array, a (2*r−1) twiddle factor (TF) constant may be used for each NTT operation for 2*r coefficients. Therefore, the twiddle factor memory 250 (e.g., an on-chip twiddle factor memory) may include (2*r−1) banks to store a collection of the respective TFs. The on-chip twiddle factor memory may be controlled by the local control circuit.

The homomorphic encryption operation apparatus 10 of one or more embodiments may easily expand the NTT structure using a 16*5-BU array to improve data processing. Although the NTT structure may be expanded, the data memory 210 and the twiddle factor memory 250 may adjust only a size of a row and a column of a memory block without changing the entire memory size.

The NTT module 230 may have a 2D BU array structure to reduce an input/output (I/O) and memory interface. The homomorphic encryption operation apparatus 10 of one or more embodiments may combine k calculation operations in the NTT module 230, thereby decreasing a number of iterations from log(n) to log(n)/k and simplifying hardware complexity of a read or write pattern of a memory (e.g., the data memory 210 or the twiddle factor memory 250).

When using a parameter set (e.g., q of N=2¹⁶ and 60-bit size) of a homomorphic application program, the NTT module 230 may include 32 BUs that are arranged in a form of eight rows and four columns. The NTT module 230 may perform a partial operation with four stages, and four iterations may be implemented to complete the entire input polynomial operation. A number of stages is provided as an example only and the number of stages may differ depending on examples.

The NTT module 230 may arrange input coefficients of non-conflict addresses in a memory block for an efficient memory access. A bank address of a memory may be represented as Equation 1 below, for example, and an order may be represented as Equation 2 below, for example.

$$BankAddr = {\sum }_{i = 0}^{⌈ {log}_{2} N / L ⌉ - 1} Addr [ L * i + L - 1 : L * i ] mod 2 BU \qquad Equation 1$$

$$Order = Addr ≫ L \qquad Equation 2$$

Here, BU denotes a number (e.g., eight in FIG. 2) of rows of the NTT module 230, L=log₂(2BU), and addr denotes order (e.g., 0˜n−1) of an input coefficient. BankAddr and Order denote a bank address and new order, respectively.

The twiddle factor memory 250 of one or more embodiments may store the twiddle factor to efficiently perform a multiplication in the NTT module 230. For example, twiddle factors may be distributed into four stages corresponding to four iterations and the respective portions may be sequentially accessed through four BU stages. The NTT module 230 may perform a partial operation in a parallel and pipeline manner.

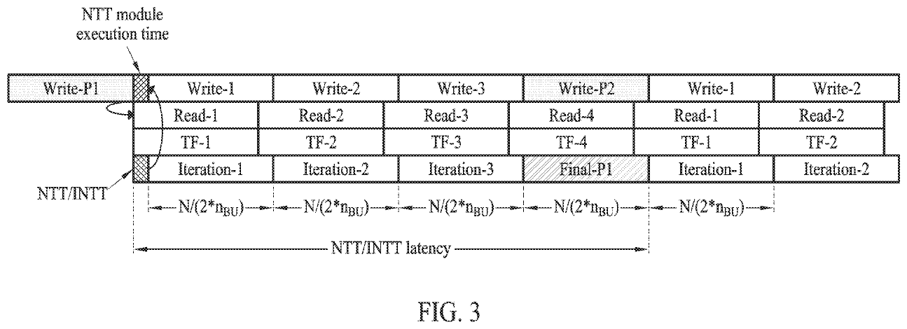

FIG. 3 illustrates an example of an NTT operation.

Referring to FIG. 3, a homomorphic encryption operation apparatus (e.g., the homomorphic encryption operation apparatus 10 of FIG. 1) may consecutively use a coefficient of a polynomial and may sequentially read a plurality of (e.g., 16) coefficients for an iteration in an NTT module (e.g., the NTT module 300 of FIG. 1). The NTT module 300 may immediately store a coefficient acquired as a result of performing an operation in a memory (e.g., the first memory 100 of FIG. 1). The stored coefficients may be transmitted for another operation when the four iterations are over or completed. The memory may store a polynomial to be used for a subsequent operation.

A latency of an NTT operation may be a sum of latency iterated by four. In a single iteration, radix-2⁴ NTT operations may be performed during 4096 cycles. A final latency of the NTT operation may be accumulated over approximately

$$4 \times ( \frac{{2}^{16}}{16} ) = 16 , 384$$

cycles.

The NTT module 300 may support a prime of up to 62 bits in size and may also support a prime of 62 bits or more. The NTT module 300 of one or more embodiments may reduce hardware complexity, may save a processing time of the NTT operation, and may accelerate a complex calculation. Through this, the NTT module 300 of one or more embodiments may increase a data throughput of a Cheon-Kim-Kim-Song (CKKS)-based homomorphic encryption system.

The homomorphic encryption operation apparatus 10 may include an iterative array NTT/INTT structure that uses a maximum 60-bit prime and may support 2¹⁶ polynomial order. The NTT/INTT architecture of the homomorphic encryption operation apparatus 10 of one or more embodiments may effectively decrease an I/O and memory interface bandwidth, compared to a one-dimensional (1D) NTT module, using a BU array configured in a form of a 2D structure (e.g., 8*4, 16*5, etc.).

Atypical NTT operation method operates 64 input coefficients by processing 32 NTT cores in parallel. Here, when 32 NTT cores n=2¹⁶, 16 iterations may need to be performed and a data memory may need to be accessed 16 times. Therefore, a large amount of register and hardware may be used by the typical NTT operation method. Also, since only a maximum of 32 NTT cores may be used, performance enhancement may be extremely difficult using the typical NTT operation method.

In the case of using an integrated data memory block for storing an intermediate result, the homomorphic encryption operation apparatus 10 of one or more embodiments may use a non-conflict data address scheme to solve an issue of difficulty in designing an efficient access pattern. The non-conflict data address scheme of one or more embodiments may only use a single data memory block for each polynomial and thus may significantly decrease the hardware complexity of a read or write pattern.

The homomorphic encryption operation apparatus 10 of one or more embodiments may efficiently perform a calculation of the NTT module 300 using an efficient storage structure of the twiddle factor. The NTT module 300 of one or more embodiments may decrease the hardware complexity and cost, may reduce a processing time, and may increase throughput of the entire homomorphic encryption system by using a structure that is easy to expand to a prime with a maximum 62-bit size and higher order.

The example of FIG. 3 may represent a data flow of the NTT operation. The NTT operation may be performed by iterating the NTT module 300 including four stages four times. The flow of the NTT operation may include sequentially writing polynomial coefficients to a memory, reading 16 coefficients for iteration from the NTT module 300, performing an NTT calculation, and storing a result again in the memory.

In the example of FIG. 3, iteration-1 may represent a step in which four stages are performed. A single iteration may include four stages and, in each stage, data memory addresses and operation signals of input coefficients input through a step counter may be transmitted. When the four stages are completed, an iteration counter may increase and an operation of a subsequent iteration may be performed. Here, an input coefficient and a twiddle factor may be loaded through an iteration count and a step count.

To complete transformation for each input polynomial, the NTT operation may implement four iterations of the NTT module 300. Latency of the NTT operation may be calculated as a sum of latency of four iterations and each iteration may be performed 4096 times in radix-24. The latency of the NTT operation according thereto may be

$$4 \times ( \frac{{2}^{16}}{{2}^{4}} ) = 16384$$

cycles.

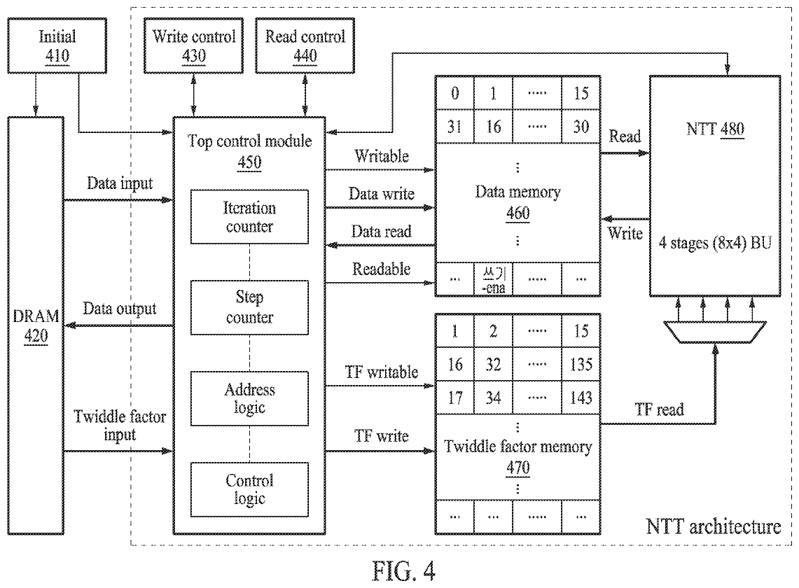

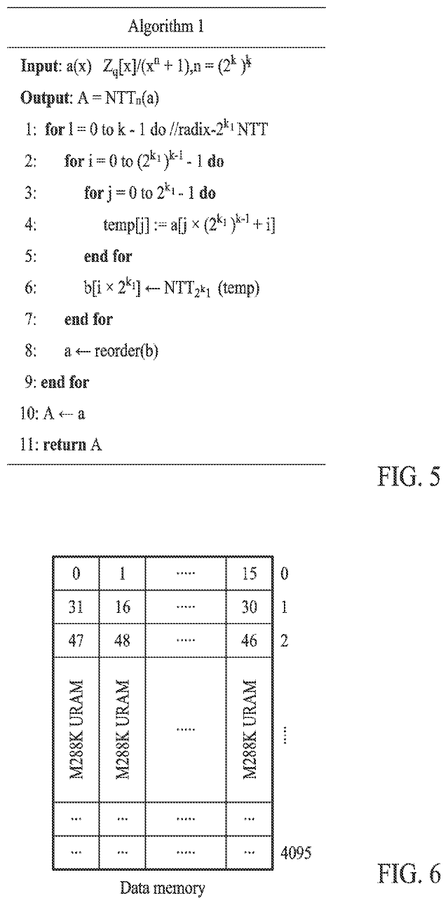

FIG. 4 illustrates an example of implementation of a field programmable gate array (FPGA)-based homomorphic encryption operation apparatus, and FIG. 5 illustrates an example of an NTT operation algorithm.

Referring to FIGS. 4 and 5, the homomorphic encryption operation apparatus 10 may include an initial module 410, a DRAM 420, a write control module 430 (e.g., a write controller), a read control module 440 (e.g., a read controller), a top control module 450 (e.g., the top control module 270 of FIG. 2), a data memory 460 (e.g., the data memory 210 of FIG. 2), a twiddle factor memory 470 (e.g., the twiddle factor memory 250 of FIG. 2), and an NTT module 480 (e.g., the NTT module 230 of FIG. 2).

The initial module 410 may initialize parameters used for the NTT operation. The DRAM 420 may store a polynomial for performing the NTT operation and a polynomial on which the NTT operation is completed. The DRAM 420 may store a twiddle factor used for the NTT operation and may transmit the twiddle factor to a local memory when performing the NTT operation.

The write control module 430 may manage a write operation of a memory (e.g., the DRAM 420, the data memory 460, and/or the twiddle factor memory 470). The write control module 430 may generate a bank address and an order for writing the coefficient of the polynomial and the twiddle factor based on an address and a control signal generated in an address logic module.

The read control module 440 may manage a read operation of the memory. The read control module 440 may generate a bank address and an order for reading the coefficient of the polynomial and the twiddle factor based on an address and a control signal generated in an address logic.

The top control module 450 may control the data memory 460 and the twiddle factor memory 470 by receiving initial data from the initial module 410, a write control signal from the write control module 430, and a read control signal from the read control module 440.

An iteration counter may manage an iteration count of the NTT module 480. A step counter may manage a progress step of a BU in the NTT module 480. For example, when 16 input coefficients are calculated at once, the step counter may measure a number of times, e.g. 4096, that an input coefficient is received.

An address logic may generate an address to be read or written from the data memory 460. A control logic may generate a control signal for controlling other modules in order.

The NTT module 480 may operate using an algorithm (e.g., a mixed-radix algorithm) of FIG. 5. The NTT module 480 may operate in such a manner that, when k1=k=4 in polynomial order N=2¹⁶, the NTT operation operates with radix-2⁴ and the NTT module 480 including four stages is iterated four times. In the algorithm of FIG. 5, four iterations of the NTT module 480 may be equal to k. The four stages may be represented as k1.

The NTT module 480 of one or more embodiments may effectively reduce a bandwidth of an I/O and memory interface by performing 8-parallel operations with 32 cores in a one NTT operation and by performing the same four times consecutively.

The twiddle factor memory 470 may store twiddle factors by dividing the twiddle factors into four sets according to a 4-stage operation and the NTT module 480 may operate in a decimal (Decimal-in-Time (DIT)) algorithm.

In another example, when k=5, the homomorphic encryption operation apparatus 10 may operate with radix-25 and may operate with 3+1 stages. That is, the homomorphic encryption operation apparatus 10 may perform an NTT operation corresponding to three stages and may additionally perform an NTT operation corresponding to a single stage. The homomorphic encryption operation apparatus 10 may differently combine k1 and k2 and may perform a homomorphic encryption operation although a polynomial order is larger, such as N=2¹⁷ and 2¹⁸.

Algorithm 1 of FIG. 5 may represent a case of performing a radix-2″ NTT operation on a polynomial with size n. In the example of FIG. 5, in n=2¹⁶, k1=4 and k=4. The NTT operation may execute k1 stages and perform k iterations in the above algorithm. 2^{k1}-point NTT may be used as fast iteration of radix-2 NTT. When the 2^{k1}-NTT operation is performed

$$( \frac{n}{{2}^{k 1}} )$$

times, reordering for a subsequent NTT operation may be performed.

FIG. 6 illustrates an example of a block diagram of data storage of a DRAM.

Referring to FIG. 6, a DRAM (e.g., the DRAM 420 of FIG. 4) may store a coefficient (e.g., an input or intermediate result) of a polynomial calculated by iterating each stage. The DRAM may sequentially store a coefficient based on a bank address and an order as in the example of FIG. 6.

When polynomial order N=2¹⁶, a block of a data memory (e.g., the data memory 460 of FIG. 4) may be divided into 16 banks and 4096 addresses. An NTT module (e.g., the NTT module 480 of FIG. 4) may load a number of inputs corresponding to 16 from 16 banks sequentially from the data memory 460 at every iteration using a non-conflict access scheme. A calculation result of the NTT module (e.g., the NTT module 480 of FIG. 4) may be stored in the same address. A number may define a corresponding input coefficient order at a storage position.

A size of storage space of the memory (e.g., the data memory 460) may be the same as an order of the polynomial. The bank address may represent a bank address corresponding to a coefficient being input. BU may represent a horizontal size (e.g., 8 in 8*4) in the NTT module 480 and may be L=log₂(2BU). Addr may represent an original address (e.g., 0 to n−1) loaded from a corresponding bank and Order may represent a new address of an input coefficient of the corresponding bank. A bank address of the memory may be the same as a size of the input coefficient.

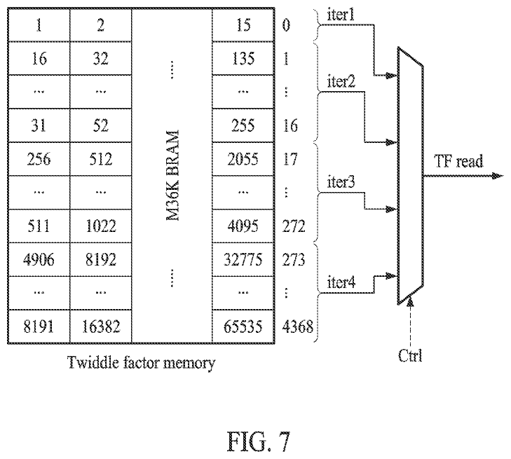

FIG. 7 illustrates an example of a block diagram of a twiddle factor memory.

Referring to FIG. 7, the twiddle factor memory (e.g., the twiddle factor memory 470 of FIG. 4) may store a twiddle factor used for an NTT operation. The twiddle factor may be determined based on a prime and an order of a polynomial. For example, 15 twiddle factors may be used at the same time to receive and calculate 16 coefficients from an 8*4 NTT module of four stages. The twiddle factors may be stored in bit-reversed order in 15 memory banks having a structure as in the example of FIG. 7.

A memory block of the twiddle factor memory 470 may be divided into 15 banks and 4369 addresses. When the NTT module (e.g., the NTT module 300 of FIG. 1) operates, 15 twiddle factors may be used and the twiddle factors may be loaded sequentially from 15 banks.

In the example of FIG. 7, the twiddle factors may be divided into four parts for four iterations of the NTT module 300. A number shown in FIG. 7 may define input coefficient order corresponding to a storage position. A number (0, 1, . . . , 4368) shown in the right side of a table may define a position of an input rotation coefficient.

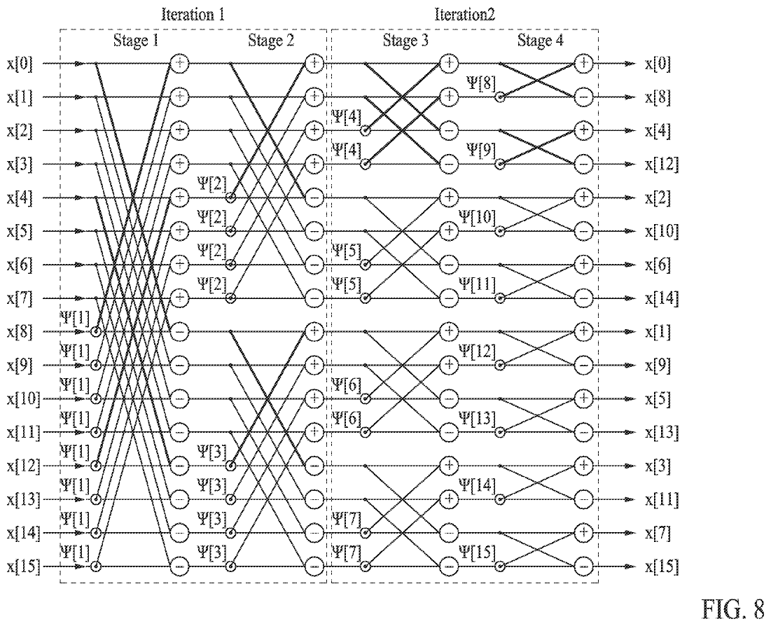

FIG. 8 illustrates an example of a memory access method of a homomorphic encryption operation apparatus (e.g., the homomorphic encryption operation apparatus 10 of FIG. 1).

Referring to FIG. 8, when N=16, an NTT operation may perform a memory access according to a stage of FIG. 8. A twiddle factor may be marked with ψ and listed in bit-reversed order.

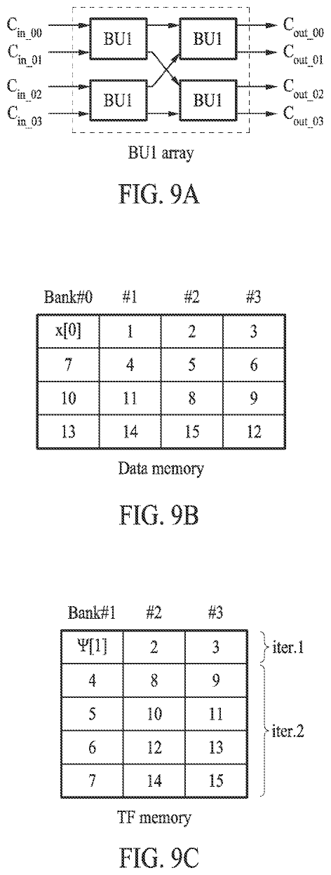

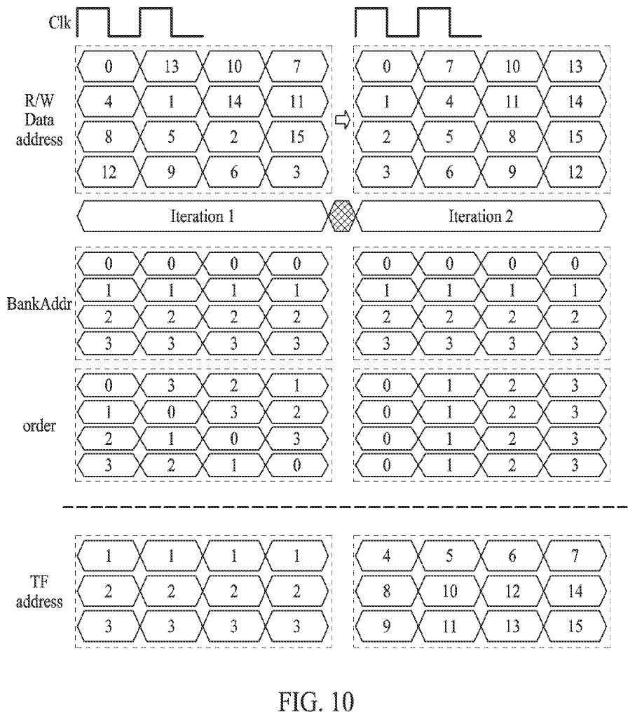

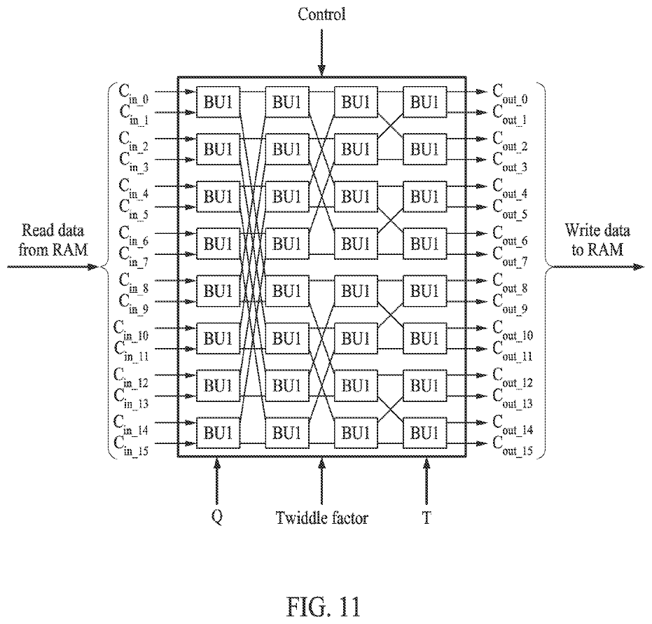

FIGS. 9A to 9C illustrate an example of a data access method of a homomorphic encryption operation apparatus (e.g., the homomorphic encryption operation apparatus 10 of FIG. 1), and FIG. 10 illustrates an example of read and write operations according to an iteration.

Referring to FIG. 9A to FIG. 10, when an NTT module (e.g., the NTT module 300 of FIG. 1) includes a 2*2 BU array, the NTT module 300 may perform an NTT operation on a 16-point polynomial through two iterations. FIG. 9B represents a data access scheme of a data memory (e.g., the data memory 210 of FIG. 2). A structure of a BU array may be a non-conflict access scheme of the data memory.

For each step (e.g., a clock cycle) in each iteration, an order of a coefficient and a bank address (BankAddr) may be calculated from an input counter. BankAddr denotes an address of a memory bank and order denotes an order of a coefficient in a corresponding bank. Coefficients may be fetched from the data memory 210 and may be fed to the NTT module 300.

A twiddle factor constant may be fetched from a twiddle factor memory (e.g., the twiddle factor memory 250 of FIG. 2) corresponding to an input counter (iteration and step counters).

FIG. 11 illustrates an example of implementation of an NTT module.

Referring to FIG. 11, the NTT module (e.g., the NTT module 230 of FIG. 2) may divide and calculate an NTT operation using a DIT algorithm. A connection between BUs may vary for every stage and an output coefficient may be stored again in the same data memory as that of an input coefficient. Additional parameters (Q, T) may be used for Barrett modular reduction.

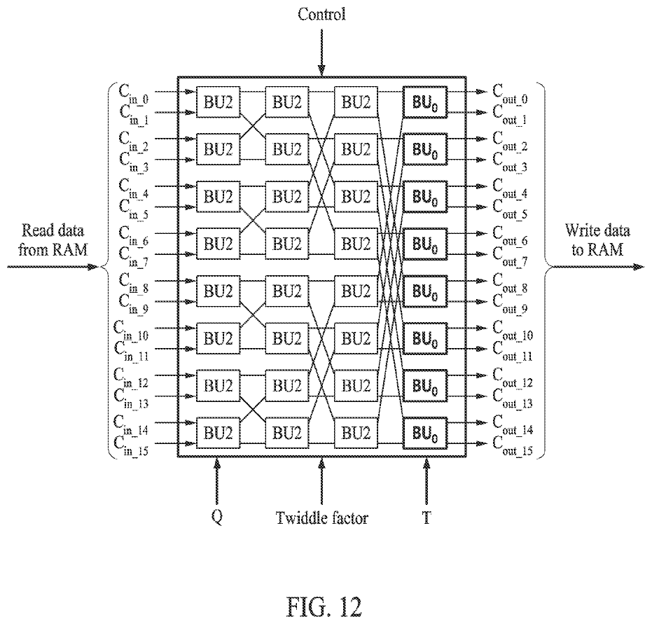

FIG. 12 illustrates an example of implementation of an INTT module.

Referring to FIG. 12, the INTT module may perform a calculation using a Decimal-in-Frequency (DIF) algorithm and a connection between BUs may be opposite to that of an NTT module (e.g., the NTT module 230. of FIG. 2). An output coefficient may be stored again in the same data memory as that of an input coefficient. Additional parameters (Q, T) may be used for Barrett modular reduction.

The INTT module may have a mirror-symmetric data flow of the NTT module 230. Except for coefficient order generated by a local control circuit, the INTT module may include BUs in a 2D array based on the DIF algorithm. The local control circuit may change a state of an FSM to correspond to an iteration. The local control circuit may change the state of the FSM for an iteration.

FIG. 13 illustrates an example of implementation of BU1 (e.g., BU1 of FIG. 11).

Referring to FIG. 13, BU1 may include a multiplier configured to perform a multiplication on a twiddle factor and a second coefficient, a modular reduction operator configured to perform a modular reduction on an output of the multiplier, an adder configured to add an output of the modular reduction operator and a first coefficient, a modular addition performer configured to perform a modular addition on an output of the adder, a subtractor configured to perform a subtraction between the first coefficient and an output of the modular reduction operator, and a modular subtraction operator configured to perform a modular subtraction operation on an output of the subtractor.

BU1 may receive two coefficients and may output new two coefficients. BU1 may include a multiplication using a twiddle factor and a modular reduction operator configured to perform a modulus operation with a Q value used in each NTT, a register for synchronization, a modular addition performer configured to perform a modulus operation on an addition value, and a modulus subtraction operator configured to perform a modulus operation on a subtraction value. A modular multiplication operator may perform all of the multiplication and the modular reduction using a Barrett algorithm.

FIG. 14 illustrates an example of implementation of BU2 (e.g., BU2 of FIG. 12).

Referring to FIG. 14, BU2 may receive two coefficients and may output new two coefficients. BU2 may include a multiplication using a twiddle factor and a modular reduction operator, a register for synchronization, a modular addition performer, and a modular subtraction operator.

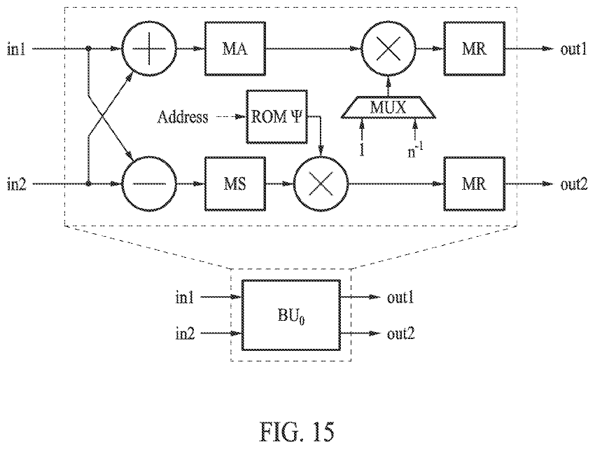

FIG. 15 illustrates an example of implementation of BU₀ (e.g., BU₀ of FIG. 12).

Referring to FIG. 15, dissimilar to BU2, BU₀ may perform a multiplication with n⁻¹ using a multiplexer (MUX). BU₀ may perform an INTT operation by multiplying 1 or n⁻¹ in a last step of the INTT operation.

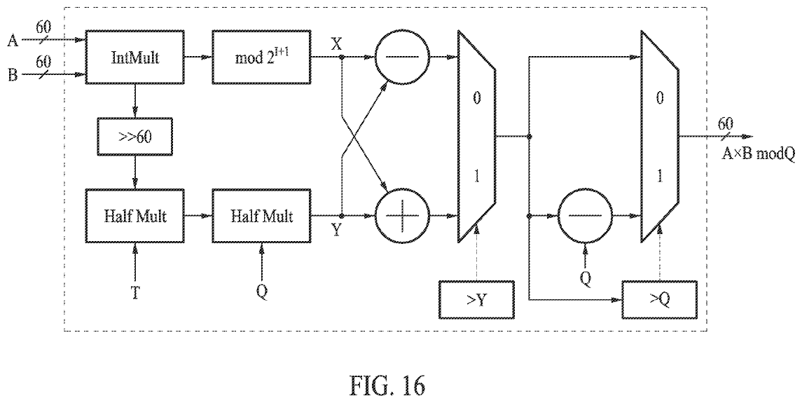

FIG. 16 illustrates an example of implementation of a modular multiplier.

Referring to FIG. 1t6, the modular multiplier may perform a modular multiplication. The modular multiplier may perform a 60-bit multiplication and may perform a modular reduction operation on prime Q. The modular multiplier may reduce a number of digital signal processors (DSPs) by using a Barrett reduction algorithm and by simplifying a constant multiplication with Q and T.

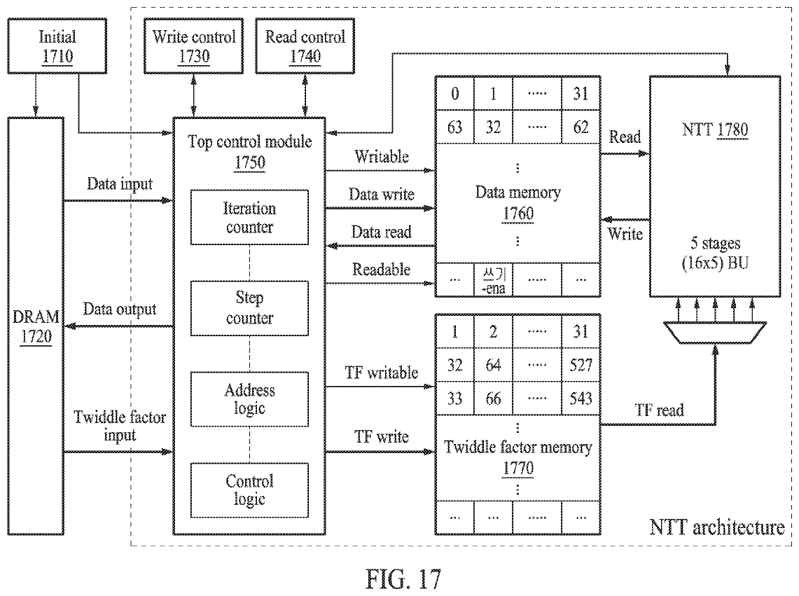

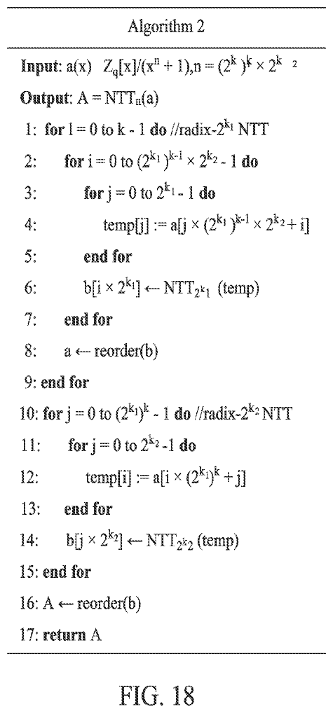

FIG. 17 illustrates an example of implementation of an FPGA-based homomorphic encryption operation apparatus, and FIG. 18 illustrates an example of an NTT operation algorithm.

Referring to FIGS. 17 and 18, the homomorphic encryption operation apparatus 10 may include an initial module 1710, a DRAM 1720, a write control module 1730, a read control module 1740, a top control module 1750, a data memory 1760, a twiddle factor memory 1770, and an NTT module 1780.

Referring to FIGS. 17 and 18, the NTT module 1780 (e.g., the NTT module 300 of FIG. 1) may perform an NTT operation using radix-2⁵. Polynomial order N=2¹⁶ and k1=5 may be used.

The NTT module 1780 may perform an NTT operation in which mixed radix-2⁵ is performed and three iterations are performed with k2=1 and k=3. Twiddle factors may be stored dividedly in three sets corresponding to three calculation iterations. That is, performing of the NTT operation may be completed in such a manner that radix-2⁵ NTT is performed through three iterations (k=3) and 16 BUs perform radix-2 NTT in parallel for a last iteration.

The NTT module 1780 may perform the NTT operation using algorithm 2 of FIG. 18. Algorithm 2 may perform a mixed-radix

$$\frac{{2}^{k 1}}{{2}^{k 2}} NTT$$

operation on a polynomial with size n. When n=2¹⁶ and 16*5 of the NTT module 1780 is used, log(n) is not divisible by k1 and algorithm 2 may be used accordingly.

In n=2¹⁶, the NTT module 1780 including five stages with k1=5, k=3, and k2=1 may be iterated three times. The NTT module 1780 may perform a radix-2 NTT operation in a final step. Through selection of k, k1, and k2, it may apply to an NTT operation that expands to n=2¹⁷ and n=2¹⁸.

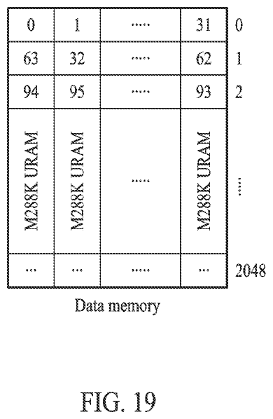

FIG. 19 illustrates an example of a block diagram of a data storage of a DRAM.

Referring to FIG. 19, the example of FIG. 19 may represent a data memory used for k1=5. When N=2¹⁶, a block of the data memory may be divided into 32 banks having 2048 addresses. When a non-conflict access scheme is used when an NTT module of one time is used, 32 input coefficients may be sequentially used. An operation result of an NTT module may be stored at the same position as that of an input coefficient.

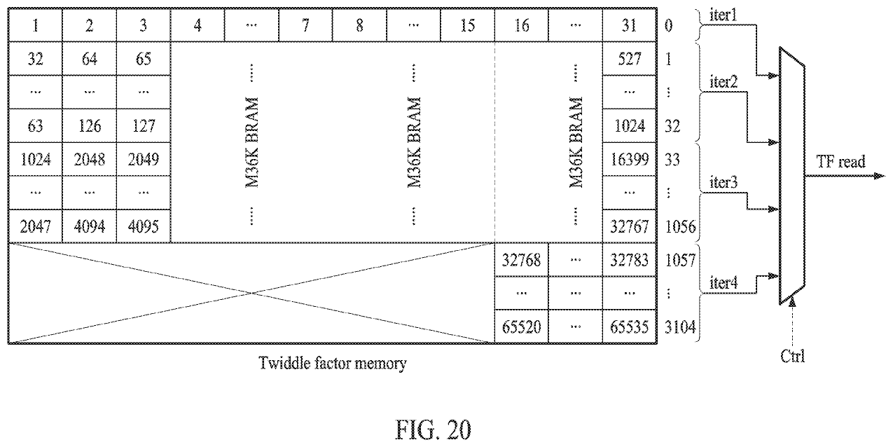

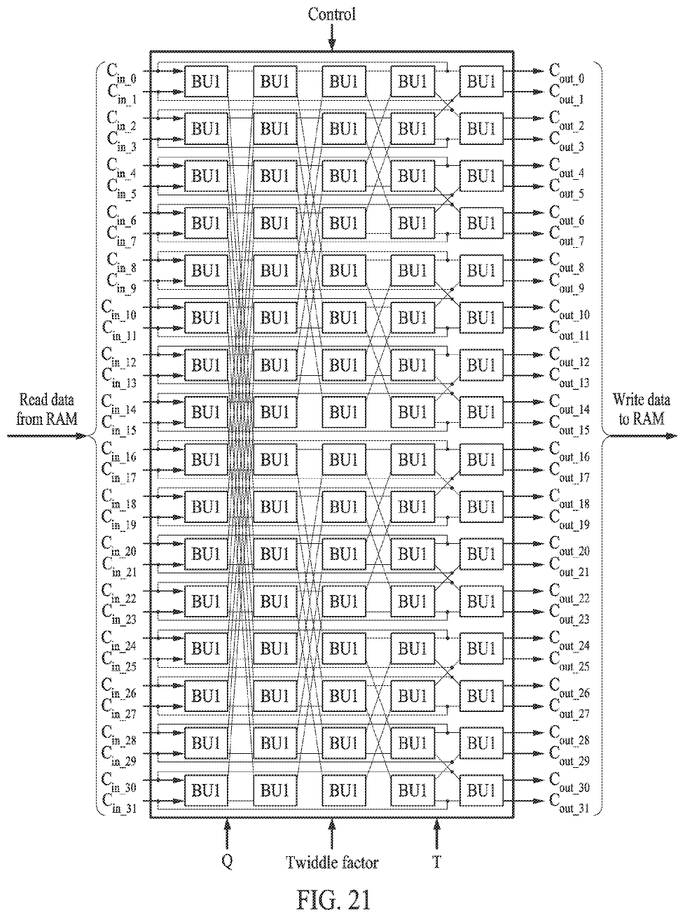

FIG. 20 illustrates an example of a block diagram of a twiddle factor memory.

Referring to FIG. 20, a tweedled memory block may be divided into 31 banks having 1057 addresses for three iterations and 16 banks having 2048 addresses for a last additional radix-2 BU. 32 input coefficients may be input to an NTT module using mixed-radix-2⁵. Twiddle factors may be allocated to a memory for sequential access of 31 banks for an NTT operation. Finally, the twiddle factors may be divided into a total of four sets for three iterations and the additional one radix-2 operation.

FIG. 21 illustrates an example of implementation of an NTT module.

Referring to FIG. 21, to improve data processing, when k1=5, the NTT module (e.g., the NTT module 300 of FIG. 1) may have a 16*5-BU array-based NTT structure. The NTT module 300 may expand for high data processing. Although the NTT structure is not expanded, a data memory and a twiddle factor (TF) memory may be implemented by adjusting a size of a row and a column of the memory block without changing the entire memory size.

The NTT module 300 of FIG. 21 may perform a partial NTT operation by performing a DIT algorithm and an output coefficient may be stored in a data memory of the same address as that of an input coefficient.

Parameters (Q, T) may be additionally input to Barrett's modular multiplication. A last line that connects BU1 and an input is connected for an additional BU operation and may be used by removing a data path to minimize hardware complexity.

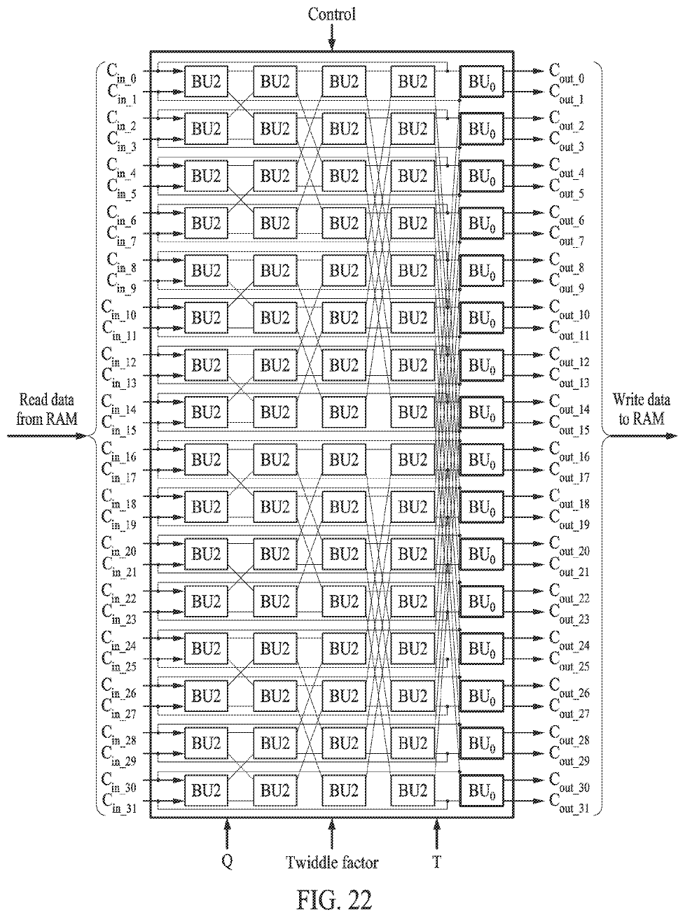

FIG. 22 illustrates an example of implementation of an INTT module.

Referring to FIG. 22, the INTT module may perform an additional BU operation by performing a DIF algorithm. A connection between BUs may be opposite to that of an NTT module. An output coefficient may be stored in a data memory of the same address as that of an input coefficient. Description made above with reference to FIGS. 14 and 15 may also apply to BU2 and BU₀ herein.

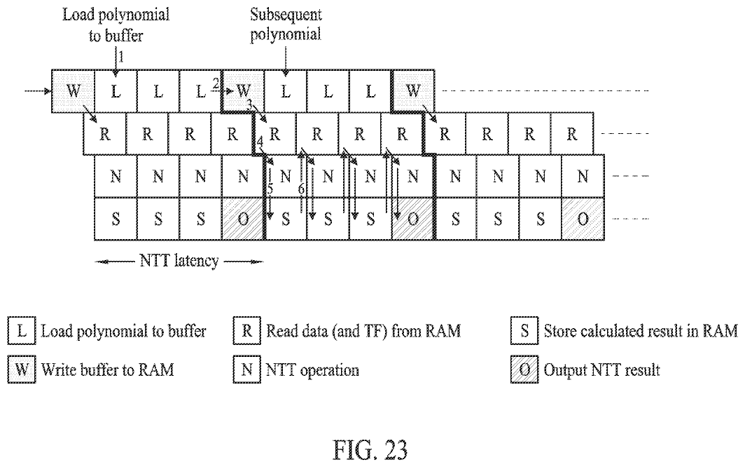

FIG. 23 illustrates an example of an NTT operation performed in a form of a pipeline.

Referring to FIG. 23, the example of FIG. 23 may represent a timing of a pipeline in polynomial order N=2¹⁶ and radix-2⁴. Each square may represent a latency in performing load, read, write, and the NTT operation when an NTT module is executed for a single iteration.

In N=2¹⁶ and radix-2⁴, the NTT operation may include six main operations. The main operations may be performed in the following order:

1. Read data into a buffer in normal order

2. Write to a memory according to an order rule

3. Read a coefficient and a twiddle factor into an NTT module

4. An NTT operation

5. Store an intermediate result in a data memory

6. Output a result of the NTT operation (in a last iteration)

In the example of FIG. 23, six operations may be fully pipelined and operate without a latency. In a last iteration, a result output of the NTT calculation and an input used for a subsequent NTT operation may be simultaneously executed.

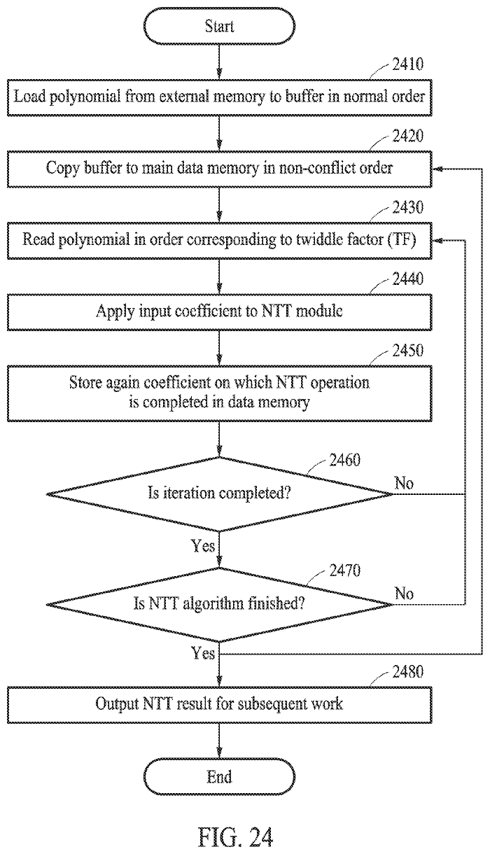

FIG. 24 is a flowchart illustrating an example of an NTT operation.

Referring to FIG. 24, in operation 2410, a controller (e.g., the controller 400 of FIG. 1) may load a polynomial from an external memory to a buffer in normal order. In operation 2420, the controller 400 may copy the buffer to a main data memory (e.g., the first memory 100 of FIG. 1) in non-conflict order.

In operation 2430, the controller 400 may read a polynomial in order corresponding to a twiddle factor. In operation 2440, the controller 400 may apply an NTT module (e.g., the NTT module 300 of FIG. 1) to an input coefficient. In operation 2450, the controller 400 may store again a coefficient on which an NTT operation is completed in a data memory.

In operation 2460, the controller 400 may determine whether an iteration is completed. Unless the iteration is completed, the controller 400 may perform again operation 2430 and otherwise, may determine whether an NTT algorithm is finished in operation 2470. Unless the NTT algorithm is finished, the controller 400 may perform again operation 2430 and, otherwise, may perform operation 2420 and may output an NTT result for a subsequent work in operation 2480.

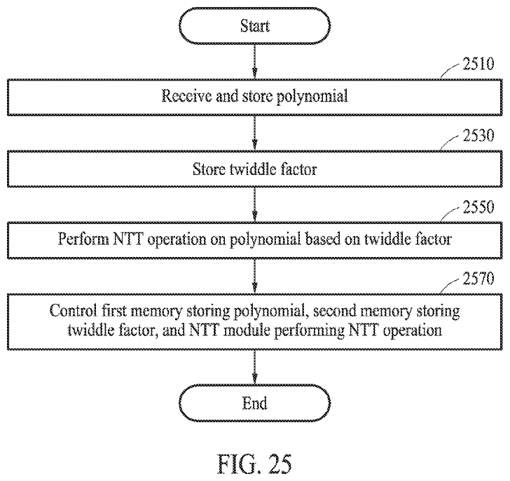

FIG. 25 is a flowchart illustrating an operation of a homomorphic encryption operation apparatus (e.g., the homomorphic encryption operation apparatus 10 of FIG. 1).

Referring to FIG. 25, in operation 2510, a first memory (e.g., the first memory 100 of FIG. 1) may receive and store a polynomial. The polynomial may include a first coefficient and a second coefficient.

In operation 2530, a second memory (e.g., the second memory 200 of FIG. 1) may store a twiddle factor. The second memory 200 may store the twiddle factor in bit-reversed order in a number of memory banks that is determined based on an order of the polynomial.

In operation 2550, an NTT module (e.g., the NTT module 300 of FIG. 1) may perform an NTT operation on the polynomial based on the twiddle factor. The NTT module 300 may perform the NTT operation by performing a modular operation on a coefficient of the polynomial using a BU array that includes a plurality of BUs.

The BU array may be configured by two-dimensionally arranging the plurality of BUs. Each of the plurality of BUs may include a multiplier configured to perform a multiplication of the twiddle factor and the second coefficient, a modular reduction operator configured to perform a modular reduction on an output of the multiplier, an adder configured to add an output of the modular reduction operator and the first coefficient, a modular addition performer configured to perform a modular addition on an output of the adder, a subtractor configured to perform a subtraction between the first coefficient and an output of the modular reduction operator, and a modular subtraction operator configured to perform a modular subtraction operation on an output of the subtractor.

The NTT operation may include a predetermined number of stages, and the NTT module 300 may perform the NTT operation based on radix corresponding to the predetermined number. The predetermined number may be determined based on an order of the polynomial. The twiddle factor may be determined based on the order of the polynomial.

The NTT module 300 may load the input coefficient that is determined based on the order of the polynomial from the first memory 100 during each iteration using an address for performing read and write operations of the first memory 100. The NTT module 300 may store an NTT operation result in the address.

In operation 2570, a controller (e.g., the controller 400 of FIG. 1) may control the first memory 100, the second memory 200, and the NTT module 300. The controller 400 may determine an iteration count of the NTT module 300. The controller 400 may measure a number of receiving an input coefficient according to a progress step of the plurality of BUs. The controller 400 may generate an address for performing read and write operations of the first memory 100.

The controller 400 may generate a bank address and order for writing a coefficient of the polynomial to the first memory 100 based on the address. The controller 400 may generate a bank address and order for reading the coefficient of the polynomial from the first memory 400 based on the address and reading the twiddle factor from the second memory 200.

The homomorphic encryption operation apparatuses, first memories, second memories, NTT modules, controllers, data memories, twiddle factor memories, top control modules, initial modules, DRAMs, write control modules, read control modules, homomorphic encryption operation apparatus 10, first memory 100, second memory 200, NTT module 300, controller 400, data memory 210, NTT module 230, twiddle factor memory 250, top control module 270, initial module 410, DRAM 420, write control module 430, read control module 440, top control module 450, data memory 460, twiddle factor memory 470, NTT module 480, initial module 1710, DRAM 1720, write control module 1730, read control module 1740, top control module 1750, data memory 1760, twiddle factor memory 1770, NTT module 1780, and other apparatuses, units, modules, devices, and components described herein with respect to FIGS. 1-25 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular t“rm “proce”sor“ ” or “comp”ter” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-25 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, bD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. An apparatus with homomorphic encryption, the apparatus comprising:
a first memory configured to receive and store a polynomial;
a second memory configured to store a twiddle factor;
a number theoretic transform (NTT) module configured to perform an NTT operation on the polynomial based on the twiddle factor; and
a controller configured to control the first memory, the second memory, and the NTT module,
wherein the NTT module comprises a butterfly unit (BU) array that comprises a plurality of BUs configured to, for the performing of the NTT operation, perform a modular operation on coefficients of the polynomial.

2. The apparatus of claim 1, wherein the BU array is configured by two-dimensionally arranging the plurality of BUs.

3. The apparatus of claim 1, wherein
the polynomial comprises a first coefficient and a second coefficient, and
for the performing of the NTT operation, each of the plurality of BUs comprises:
a multiplier configured to perform a multiplication on the twiddle factor and the second coefficient;
a modular reduction operator configured to perform a modular reduction on an output of the multiplier;
an adder configured to add an output of the modular reduction operator and the first coefficient;
a modular addition performer configured to perform a modular addition on an output of the adder;
a subtractor configured to perform a subtraction between the first coefficient and an output of the modular reduction operator; and
a modular subtraction operator configured to perform a modular subtraction operation on an output of the subtractor.

4. The apparatus of claim 1, wherein
the NTT operation comprises a predetermined number of stages, and
for the performing of the NTT operation, the NTT module is configured to perform the NTT operation based on a radix corresponding to the predetermined number.

5. The apparatus of claim 4, wherein the predetermined number is determined based on an order of the polynomial.

6. The apparatus of claim 1, wherein the twiddle factor is determined based on an order of the polynomial.

7. The apparatus of claim 1, wherein the second memory is configured to, for the storing of the twiddle factor, store the twiddle factor in bit-reversed order in a number of memory banks that is determined based on an order of the polynomial.

8. The apparatus of claim 1, wherein, for the controlling, the controller is configured to:
determine an iteration count of the NTT module;
measure a number of receptions of an input coefficient according to a progress step of the plurality of BUs; and
generate an address for performing read and write operations of the first memory.

9. The apparatus of claim 8, wherein, for the controlling, the controller is configured to:
generate a bank address and an order for writing a coefficient of the polynomial to the first memory based on the address; and
generate a bank address and an order for reading the coefficient of the polynomial from the first memory based on the address and reading the twiddle factor from the second memory.

10. The apparatus of claim 8, wherein, for the performing of the NTT operation, the NTT module is configured to:
load the input coefficient that is determined based on an order of the polynomial from the first memory during each iteration using the address; and
store an NTT operation result in the address.

11. A method with homomorphic encryption, the method comprising:
receiving and storing a polynomial;
storing a twiddle factor;
performing a number theoretic transform (NTT) operation on the polynomial based on the twiddle factor; and
controlling a first memory configured to store the polynomial, a second memory configured to store the twiddle factor, and an NTT module configured to perform the NTT operation,
wherein the performing of the NTT operation comprises performing the NTT operation by performing a modular operation on coefficients of the polynomial using a butterfly unit (BU) array that comprises a plurality of BUs.

12. The method of claim 11, wherein the BU array is configured by two-dimensionally arranging the plurality of BUs.

13. The method of claim 11, wherein
the polynomial comprises a first coefficient and a second coefficient, and
the performing of the NTT operation using the BU array that comprises the plurality of BUs comprises:
performing a multiplication on the twiddle factor and the second coefficient;
performing a modular reduction on a result of the multiplication;
performing an addition on a result of the modular reduction and the first coefficient;
performing a modular addition on a result of the addition;
performing a subtraction between the first coefficient and a result of the modular reduction; and
performing a modular subtraction operation on a result of the subtraction.

14. The method of claim 11, wherein
the NTT operation comprises a predetermined number of stages, and
the performing of the NTT operation comprises performing the NTT operation based on a radix corresponding to the predetermined number.

15. The method of claim 14, wherein the predetermined number is determined based on an order of the polynomial.

16. The method of claim 11, wherein the twiddle factor is determined based on an order of the polynomial.

17. The method of claim 11, wherein the storing of the twiddle factor comprises storing the twiddle factor in bit-reversed order in a number of memory banks that is determined based on an order of the polynomial.

18. The method of claim 11, wherein the controlling comprises:
determining an iteration count of the NTT module;
measuring a number of receptions of an input coefficient according to a progress step of the plurality of BUs; and
generating an address for performing read and write operations of the first memory.

19. The method of claim 18, wherein the controlling further comprises:
generating a bank address and an order for writing a coefficient of the polynomial to the first memory based on the address; and
generating a bank address and an order for reading the coefficient of the polynomial from the first memory based on the address and reading the twiddle factor from the second memory.

20. The method of claim 18, wherein the performing of the NTT operation comprises:
retrieving the input coefficient that is determined based on an order of the polynomial from the first memory during each iteration using the address; and
storing an NTT operation result in the address.
